(19) United States
(12) Patent Application Publication
(10) Pub. No.: US 2004/0055165 A1
(43) Pub. Date: Mar. 25, 2004

(54) Julienne knife

(76) Inventor: Edmund Chan, El Cerrito, CA (US)

Correspondence Address: EDMUND CHAN, 2114 JUNCTION AV., EL CERRITO, CA, 94530, US

(21) Appl. No.: 10/252,996

(22) Filed: Sep. 23, 2002

(51) Int. Cl. B26B 3/00

(52) U.S. Cl. 30/305

(57) ABSTRACT

Julienne Knife with a plurality of knife blades each blade having a bolt retaining aperture. A U shaped blade assembly holding member includes a handle portion. A first through bolt removably retains the knife blades allowing the blades to rotate about the first through bolt. A second through bolt acts as a stop for the opposite ends of the knife blades. A pair of nuts retain the first and second through bolts. A plurality of spacers evenly separate the knife blades from each other. A preferred embodiment includes when the knife blades are rotated about the first through bolt, the opposite end of the knife blade is made available to the user so that the user has easy access to both ends of the the knife blades.

### CROSS REFERENCE TO RELATED APPLICATIONS

Not Applicable

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of cutting devices and more specifically to a julienne knife.

Cutting utensils for the cutting of foods such as meats, vegetables, fruits, pasta and the like have been in use for many hundreds of years. Cutting foods into strips helps cook food more evenly and quickly. Uncooked foods such as green onions have an improved texture and taste when cut into thin strips.

A cutting device usually includes a sharp cutting blade and a handle portion attached to the blade so that the user can draw the blade over the item to be cut thereby sectioning the food item into a plurality of sliced pieces.

A process called julienne cutting defines a process where a person cuts a food item into a plurality of uniformly wide strips. Although a person can use a conventional knife to slice food into strips, the process tends to be time consuming, and, if done repeatedly, can cause hand fatigue. Additionally, it requires skill and patience to cut foods in to uniformly wide slices. A person who partakes in the julienne cutting process only occasionally may have a hard time getting a consistent result.

### BRIEF SUMMARY OF THE INVENTION

The primary object of the invention is to provide a cutting device that helps cut food such as vegetables meat, pasta fruit and the like into a plurality of uniformly wide strips.

Another object of the invention is to provide a cutting device that employs a plurality of removable replaceable knife blades.

Another object of the invention is to provide a cutting device where a first end of each knife blade can be rotated to a second end when the first end becomes dull.

A further object of the invention is to provide a cutting device that is easy to clean.

Yet another object of the invention is to provide a cutting device that is economical to manufacture.

Other objects and advantages of the present invention will become apparent from the following descriptions, taken in connection with the accompanying drawings, wherein, by way of illustration and example, an embodiment of the present invention is disclosed.

In accordance with a preferred embodiment of the invention, there is disclosed julienne knife comprising: a plurality of knife blades each blade having a bolt retaining aperture, a U shaped blade assembly holding member including a handle portion, a first through bolt that removably retains said knife blades allowing said blades to rotate about said first through bolt, a second through bolt that acts as a stop for the opposite ends of said knife blades, a pair of nuts that retain said first and second through bolts, and a plurality of spacers that evenly separate said knife blades from each other.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of the invention.

FIG. 2 is a plan view of the present invention FIG. 3 is a side section view of the present invention

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as a representative basis for teaching one skilled in the art to employ the present invention in virtually any appropriately detailed system, structure or manner.

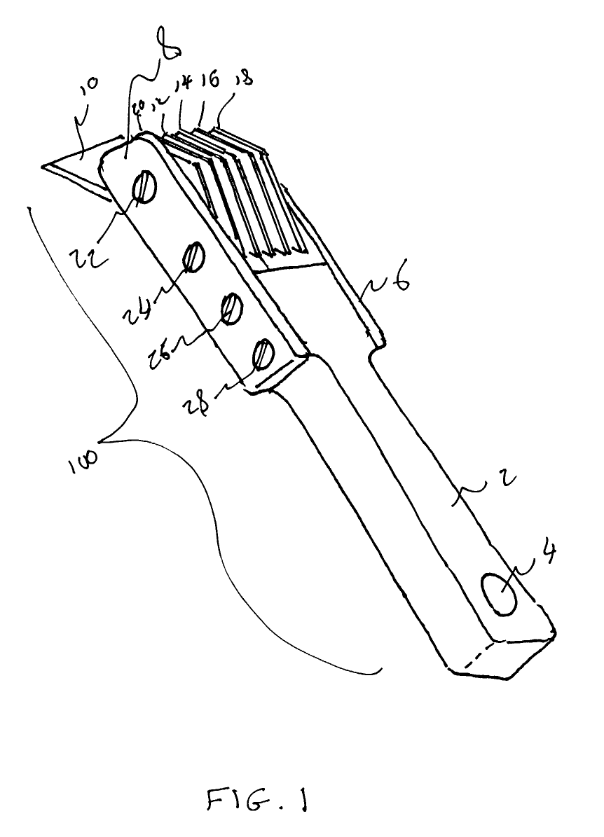

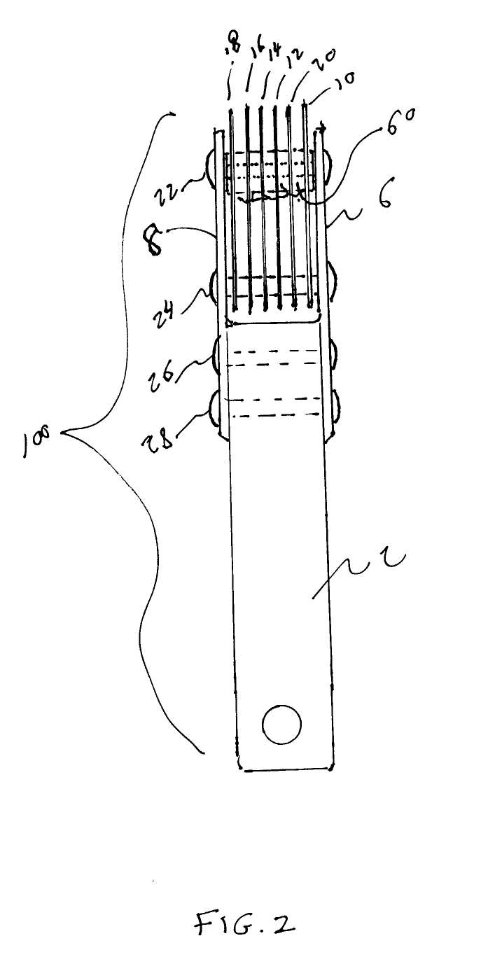

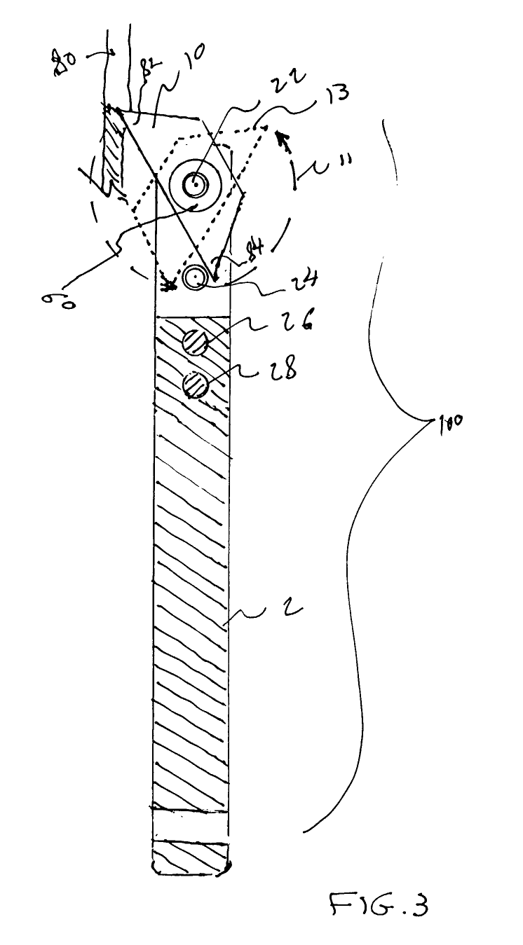

Referring now to FIG. 1 we a perspective view of the present invention 100. The device 100 is comprised of a handle portion 2 and integral arms 6, 8 that form a U shaped portion that helps retain a plurality of knife blades 10, 12, 14, 16, 18, 20. Arms 6, 8 are held onto handle 2 by bolts 26, 28, however, arms 6, 8 may be integrally molded as an extension of handle 2. Aperture 4 allows the user to hand the device 100 on a hook or the like. FIG. 2 shows a plan view of the julienne knife 100. Blades 10, 12, 14, 16, 18, 20 are evenly spaced one from the other by washers 60. FIG. 3 shows a side section view of the present invention 100. Blade 10 can be seen as being pinned by cross bolt 22. Blade end 82 is cutting into a food item such as a slice of a vegetable 80. The knife blade 10 is prevented from rotating completely by through bolt 24. When knife blade end 82 becomes dull, the user can rotate the blade as shown by dotted line 11 so that blade end 84 is exposed as shown by dotted line 13. The user can then turn the handle upside down an perform similar cutting activities with blade end 84. The above described and illustrated julienne knife lets a user slice a plurality of uniform width food items in an easy time efficient way. The blades are removable and replaceable. The blade ends are rotatable thereby doubling the useful life of the knife assembly. The product of the present invention is easy to manufacture and economical to produce.

While the invention has been described in connection With a preferred embodiment, it is not intended to limit the scope of the invention to the particular form set forth, but on the contrary, it is intended to cover such alternatives, modifications, and equivalents as may be included within the spirit and scope of the invention as defined by the appended claims.

What is claimed is:

1. Julienne Knife comprising:
a plurality of knife blades each blade having a bolt retaining aperture;
a U shaped blade assembly holding member including a handle portion;
a first through bolt that removably retains said knife blades allowing said blades to rotate about said first through bolt;
a second through bolt that acts as a stop for the opposite ends of said knife blades;
a pair of nuts that retain said first and second through bolts; and
a plurality of spacers that evenly separate said knife blades from each other.

2. Julienne Knife as claimed in claim 1 wherein when said knife blades are rotated about said first through bolt, the opposite end of said knife blade is made available to the user so that the user has easy access to both ends of the said knife blades.
